(19) United States
(12) Patent Application Publication
(10) Pub. No.: US 2024/0280129 A1
(43) Pub. Date: Aug. 22, 2024

(54) CLIP STRUCTURE AND PIN MEMBER

(71) Applicant: NIFCO INC., Yokosuka-shi, Kanagawa (JP)

(72) Inventor: Jemin HWANG, Yokosuka-shi, Kanagawa (JP)

(73) Assignee: NIFCO INC., Yokosuka-shi, Kanagawa (JP)

(21) Appl. No.: 18/004,204

(22) PCT Filed: Mar. 29, 2021
(86) PCT No.: PCT/JP2021/013253

§ 371 Date: Jul. 17, 2023

(30) Foreign Application Priority Data
Jul. 8, 2020 (JP) 2020-117576

(51) Int. Cl. F16B 19/10

(52) U.S. Cl. CPC F16B 19/1081

(57) ABSTRACT

A clip structure and a pin member that have a high shear strength are provided. A grommet member includes a projecting portion, which has a ring shape or a cylindrical shape where an insertion hole is centered and which projects, around the periphery of the insertion hole, from the opposite side of a seat portion from leg portions. On the other hand, a pin member includes a recessed groove portion, which has a ring shape whose part is formed by a support portion, which has a ring shape or a cylindrical shape and is connected, on an extension of a shaft portion, between a middle portion of the shaft portion and a flange portion. The projecting portion is inserted into the recessed groove portion behind the seat portion. In the recessed groove portion, the side of the support portion faces the projecting portion behind the seat portion.

### TECHNICAL FIELD

The present invention relates to a clip structure and a pin member that are to be mounted into a mounting member.

### BACKGROUND ART

For example, there has hitherto been a clip that is described in PTL 1 below, that includes a grommet and a pin, and that serves as a structure usable for mounting a bumper to a body of an automobile or the like (hereinafter referred to as “the invention publicly known in the literature”). In the invention publicly known in the literature, the grommet formed in a part of a bumper retainer has a plurality of legs to be inserted into the body, and a hole into which the pin is inserted to open the legs is formed at the center between the legs. A thin flange is formed at the head of the pin. Pressing the flange against the grommet causes the invention publicly known in the literature to achieve a waterproof function.

### CITATION LIST

### Patent Literature

PTL 1: Japanese Patent No. 5319586

### SUMMARY OF INVENTION

### Technical Problem

However, if the bumper retainer (grommet) is moved, due to a bumper load or an external force, in a direction in which the bumper retainer shifts from the body, a force is applied to the pin in a direction in which the pin is sheared. Thus, the pin is inclined to deform the flange.

The present invention is proposed in view of such circumstances. That is, an object of the present invention is to provide a clip structure and a pin member that have a high shear strength.

### Solution to Problem

To achieve the above object, a clip structure according to the present invention includes: a grommet member having an insertion hole around which a leg portion is disposed, the leg portion being formed on a seat portion configured to face a mounting member, the leg portion being configured to be inserted into the mounting member; and a pin member including a shaft portion that is inserted into the insertion hole and that is engaged with the leg portion. The grommet member includes a projecting portion projecting toward an opposite side of the seat portion from the leg portion. The pin member includes a support portion configured to come into contact with the projecting portion, in a direction crossing the shaft portion, at a position closer to the projecting portion than the seat portion.

In the clip structure according to the present invention, the shaft portion and the support portion are connected to each other, a flange portion is connected to the support portion, and the support portion and the flange portion form a shape of a recessed groove into which the projecting portion is inserted.

In the clip structure according to the present invention, the flange portion includes a thin portion configured to come into pressure contact with the seat portion.

In the clip structure according to the present invention, the leg portion has a rib configured to come into contact with an edge of a hole of the mounting member.

In the clip structure according to the present invention, the projecting portion has a ring shape around an edge of the insertion hole, and the support portion has a ring shape on an extension of the shaft portion.

A pin member according to the present invention is configured to be engaged with a grommet member having an insertion hole around which a leg portion is disposed, the leg portion being formed on a seat portion configured to face a mounting member, the leg portion being configured to be inserted into the mounting member. The pin member includes: a shaft portion that is configured to be inserted into the insertion hole and that is configured to be engaged with the leg portion; a recessed groove portion that has a ring shape and that is recessed, on an extension of the shaft portion on an opposite side of the seat portion from the leg portion, toward a side opposite to the shaft portion, a part of the grommet member being configured to be inserted into the recessed groove portion; a support portion that is connected on the extension of the shaft portion and that is a part of the recessed groove portion; and a thin portion that is connected to the recessed groove portion and that is configured to come into pressure contact with the seat portion.

### ADVANTAGEOUS EFFECTS OF INVENTION

In the clip structure according to the present invention, the grommet member includes the projecting portion projecting toward the opposite side of the seat portion from the leg portion, and the pin member includes the support portion configured to come into contact with the projecting portion, in the direction crossing the shaft portion, at the position closer to the projecting portion than the seat portion. Even when a certain force is applied to the grommet member in the direction in which the grommet member shifts from the mounting member and that crosses the shaft portion of the pin member, the projecting portion of the grommet member is located at a position to which the pin member is to be inclined, and the support portion of the pin member comes into contact with the projecting portion, thus inhibiting the pin member from being inclined. That is, it can be said that the present invention has a high shear strength.

In the clip structure according to the present invention, the shaft portion and the support portion are connected to each other, the flange portion is connected to the support portion, and the support portion and the flange portion form the shape of the recessed groove into which the projecting portion is inserted. That is, the projecting portion of the grommet member is inserted into the recessed groove portion of the pin member. In this state, even when a certain force is applied to the grommet member in the direction in which the grommet member shifts from the mounting member, the pin member including the recessed groove portion into which the projecting portion of the grommet member is inserted is inhibited from being inclined. That is, it can be said that the present invention has a high shear strength.

In the clip structure according to the present invention, the flange portion includes the thin portion configured to come into pressure contact with the seat portion. That is, since the pin member is inhibited from being inclined, the flange is not deformed and comes into pressure contact with the seat portion of the grommet member in a state in which the flange portion covers the projecting portion, thus enabling the present invention to be watertight.

In the clip structure according to the present invention, the leg portion has the rib configured to come into contact with the edge of the hole of the mounting member. That is, the rib increases the rigidity of the leg portion. Thus, the grommet member is less likely to shift. In addition, even when a certain force is applied to the grommet member in the direction in which the grommet member shifts from the mounting member, the rib of the leg portion of the grommet member comes into contact with the edge of the hole of the mounting member. Thus, the grommet member is less likely to shift.

In the clip structure according to the present invention, the projecting portion has the ring shape around the edge of the insertion hole, and the support portion has the ring shape on the extension of the shaft portion. With this configuration, the circumferential surface of the support portion of the pin member and the circumferential surface of the projecting portion of the grommet member entirely come into contact with each other. Accordingly, the support portion and the projecting portion are strong, thus achieving a high shear strength. In addition, since the projecting portion is located around the edge of the insertion hole, and the support portion is located on the shaft portion of the pin member, the pin member is inhibited from being inclined compared with a case in which the projecting portion and the support portion are formed at respective positions away from the insertion hole and the shaft portion. That is, it can be said that the present invention has a high shear strength.

The pin member according to the present invention includes: the shaft portion that is configured to be inserted into the insertion hole and that is configured to be engaged with the leg portion; the recessed groove portion that has the ring shape and that is recessed, on the extension of the shaft portion on the opposite side of the seat portion from the leg portion, toward the side opposite to the shaft portion, the part of the grommet member being configured to be inserted into the recessed groove portion; the support portion that is connected on the extension of the shaft portion and that is the part of the recessed groove portion; and the thin portion that is connected to the recessed groove portion and that is configured to come into pressure contact with the seat portion. Thus, the pin member achieves effects similar to those of the clip structure described above.

### BRIEF DESCRIPTION OF DRAWINGS

FIG. 1 is a perspective view of a grommet member of a clip structure according to an embodiment of the present invention when viewed from the side where an insertion hole is located.

FIG. 2 is a perspective view of the grommet member of the clip structure according to the embodiment of the present invention when viewed from the side where leg portions are located.

FIG. 3 is a perspective view of a pin member of the clip structure according to the embodiment of the present invention when viewed from the side where a flange portion is located.

FIG. 4 is a perspective view of the pin member of the clip structure according to the embodiment of the present invention when viewed from the side where a shaft portion is located.

FIG. 5 is a perspective view of the clip structure according to the embodiment of the present invention when viewed from the side from which the pin member is inserted.

FIG. 6 is a perspective view of the clip structure according to the embodiment of the present invention when viewed from the side toward which the pin member is inserted.

FIG. 7 is a rear view of the clip structure according to the embodiment of the present invention when viewed from the side toward which the pin member is inserted.

FIG. 8 is a sectional view of the clip structure according to the embodiment of the present invention taken along section VIII-VIII in FIG. 7.

FIG. 9 is a sectional view of the clip structure according to the embodiment of the present invention taken along section IX-IX in FIG. 7.

### DESCRIPTION OF EMBODIMENTS

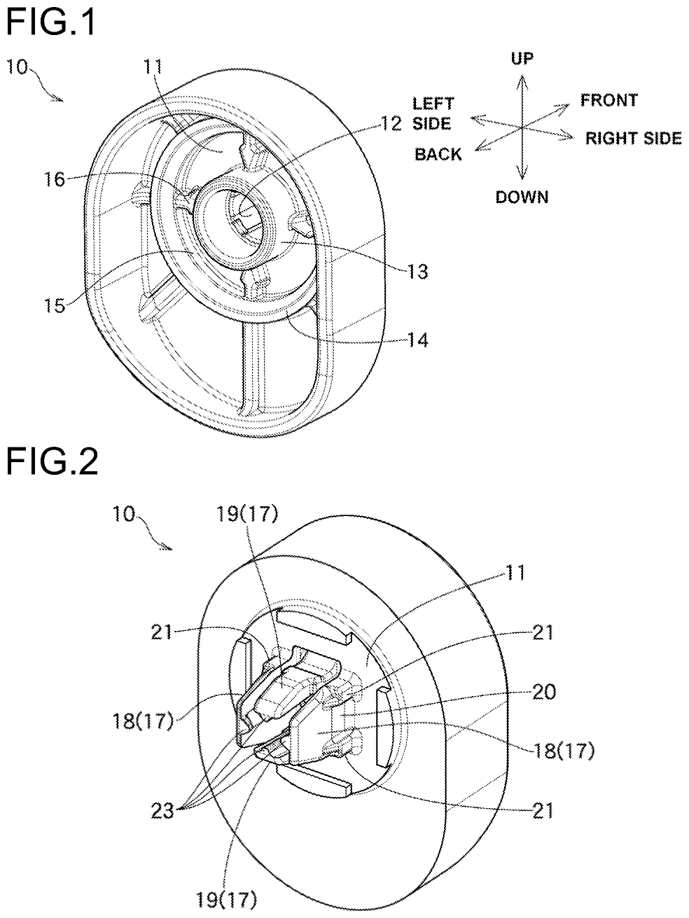

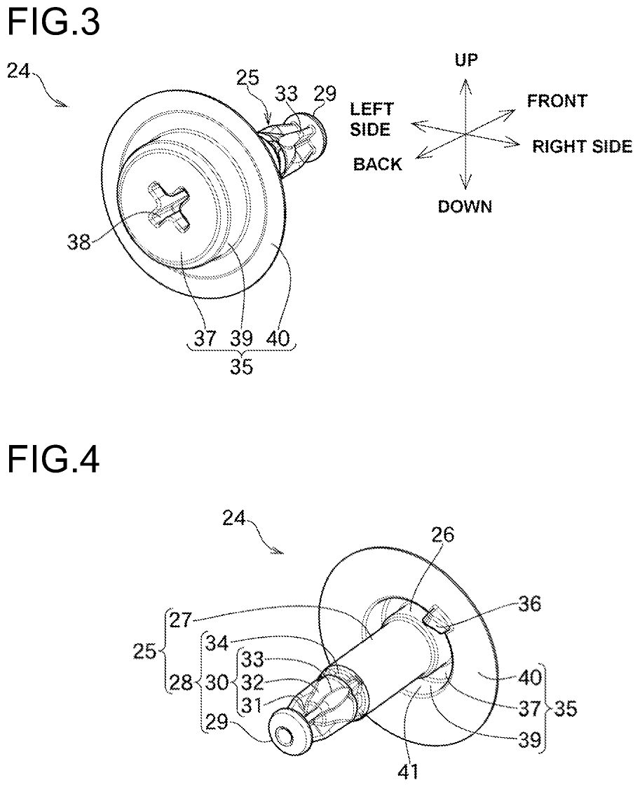

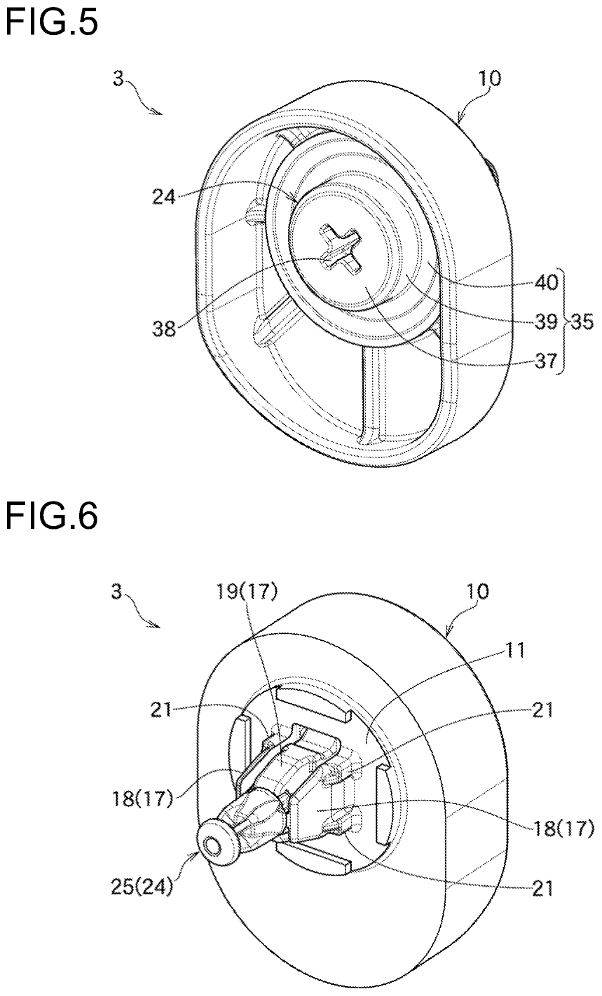

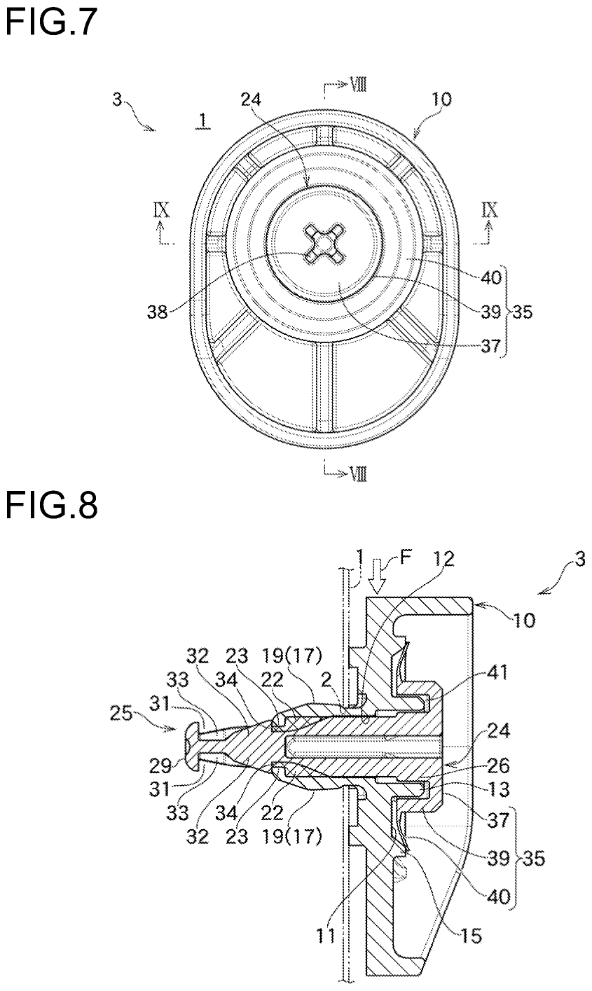

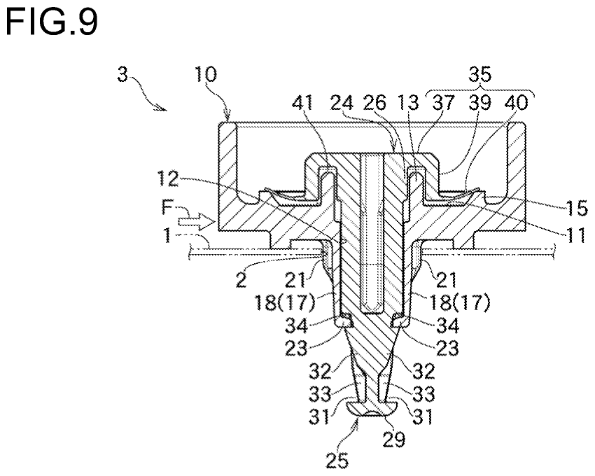

A clip structure according to an embodiment of the present invention will be described below with reference to the drawings. FIGS. 1 and 2 illustrate a grommet member 10, which forms a clip structure 3. FIGS. 3 and 4 illustrate a pin member 24, which forms the clip structure 3. FIGS. 5 and 6 illustrate the clip structure 3. FIGS. 7, 8, and 9 illustrate the exterior and sections of the clip structure 3 in a state in which the clip structure 3 is mounted into a mounting member 1. As illustrated in FIGS. 1, 2, 3, 4, 5, and 6, in the clip structure 3, the pin member 24 is to be mounted into the grommet member 10. As illustrated in FIGS. 7, 8, and 9, the clip structure 3 is mounted into the mounting member 1. The clip structure 3 is provided for, for example, a bumper retainer usable when a bumper is mounted to a body of an automobile (the automobile, the body, the bumper, and the bumper retainer are not illustrated). That is, the mounting member 1 is, for example, a body of an automobile, and the grommet member 10 is formed in, for example, a bumper retainer. In a state in which a bumper is mounted to the bumper retainer, the bumper retainer is mounted to the body. Thus, the bumper is mounted to the body. The number of clip structures 3 in the present embodiment is one. However, the number of clip structures 3 to be formed in a bumper retainer may be any number.

In the following description, the side toward which the pin member 24 is inserted is the front, the side from which the pin member 24 is inserted is the back, and directions orthogonal to the direction in which the pin member 24 is inserted are the up direction, the down direction, the left side direction, and the right side direction (see FIGS. 1 and 3).

As illustrated in FIG. 1, the grommet member 10 includes a seat portion 11 facing the body, which is the mounting member 1. The seat portion 11 has an insertion hole 12, into which the pin member 24 is inserted. A projecting portion 13 is formed, around the periphery of the insertion hole 12, on the back of the seat portion 11. The projecting portion 13 has a ring shape or a cylindrical shape where the insertion hole 12 is centered. The projecting portion 13 projects toward the back. A wall portion 14 is formed, around the projecting portion 13, on the back of the seat portion 11. The wall portion 14 has a ring shape or a cylindrical shape having the same axis as the projecting portion 13. The wall portion 14 projects toward the back. That is, the seat portion 11 is disposed so as to be recessed relative to the height of the wall portion 14. A step portion 15 is formed on the part where the seat portion 11 and the wall portion 14 are connected. The step portion 15 has a ring shape along the wall portion 14. A plurality of step pieces 16 is formed, between the projecting portion 13 and the step portion 15, on the seat portion 11. The step pieces 16 form a radial shape where the projecting portion 13 is centered. The step pieces 16 are disposed at substantially regular intervals in the circumferential direction of the projecting portion 13.

As illustrated in FIG. 2, a plurality of leg portions 17 is formed, around the periphery of the insertion hole 12, on the bottom of the seat portion 11. The leg portions 17 each have a substantially plate-like shape and project toward the front. The leg portions 17 include a pair of first leg portions 18, where the insertion hole 12 is centered and which face each other in the left-right direction, and a pair of second leg portions 19, where the insertion hole 12 is centered and which are adjacent to the first leg portions 18 and face each other in the up-down direction. A base portion 20, which is the part of the first leg portion 18 connected to the seat portion 11, has ribs 21 on the outer side thereof. The ribs 21 are formed at two positions and are disposed at upper and lower end portions of the base portion 20. A bulging portion 22 is formed on the inner side of the second leg portion 19 (see FIG. 8). Locking pieces 23, which project toward the inside that the leg portions 18 and 19 face, are formed at tip end portions of the respective leg portions 18 and 19. The locking piece 23 of the second leg portion 19 is connected to the bulging portion 22.

As illustrated in FIGS. 3 and 4, the pin member 24 includes a shaft portion 25, which is inserted into the insertion hole 12 of the grommet member 10, a support portion 26, which is connected on an extension of the shaft portion 25, and a flange portion 35, which is connected to the support portion 26 and is mounted to the seat portion 11. The shaft portion 25 has a substantially hollow cylindrical shape or columnar shape. The shaft portion 25 includes a middle portion 27, which extends toward the front from the support portion 26, and a front-end locking portion 28, which extends toward the front from the middle portion 27. The front-end locking portion 28 includes a front end portion 29, which is a front end, a temporary fixing portion 30, which extends toward the back from the front end portion 29, and a locking groove portion 34, which is connected to the back of the temporary fixing portion 30. The front end portion 29 has a disc shape smaller than that of the flange portion 35. The temporary fixing portion 30 is connected to the center of the front end portion 29. The temporary fixing portion 30 has a temporary fixing groove portion 31, an inclined surface 32, which spreads sideward toward the back, and a plurality of partition portions 33, which projects sideward. The partition portions 33 extend from the front end portion 29 to the inclined surface 32 and are disposed at substantially regular intervals in the circumferential direction of the shaft portion 25. Thus, the temporary fixing groove portion 31 and the inclined surface 32 are partitioned by the partition portions 33. The locking groove portion 34 is recessed toward the center of the shaft portion 25 and is partitioned at the same intervals as the partition portions 33. The middle portion 27, which extends from the back of the locking groove portion 34, has an even cylindrical shape or columnar shape. The support portion 26 has a ring shape or a cylindrical shape.

The flange portion 35 includes a top portion 37, which is circular and flat, a cover portion 39, which has a ring shape or a cylindrical shape and projects toward the front from the periphery of the top portion 37, and a thin portion 40, which has a ring shape and projects toward the outside from the front end of the cover portion 39. An insertion groove 38, into which, for example, a tool (not illustrated) is inserted, is formed in the back of the top portion 37. The support portion 26 is connected to the front center of the top portion 37. The support portion 26 has a ring shape or a cylindrical shape and is disposed so as to face the inside of the cover portion 39. The support portion 26 and the cover portion 39 have concentric circular shapes where the shaft portion 25 is centered. A recessed groove portion 41, which has a recessed groove shape, is formed in the space surrounded by the support portion 26, the cover portion 39, and the top portion 37. That is, the recessed groove portion 41 has a ring shape whose part is formed by the support portion 26 and is recessed, on an extension of the shaft portion 25, toward the side opposite to the direction in which the shaft portion 25 extends. The thin portion 40 has a thickness smaller than the top portion 37 and the cover portion 39 and is thus easily bent. Inclined projecting pieces 36, which project toward the front and are inclined in the circumferential direction of the thin portion 40, are formed, on the thin portion 40, in the vicinities of the part where the thin portion 40 and the cover portion 39 are connected. The inclined projecting pieces 36 are formed at two positions and are disposed on the respective sides where the shaft portion 25 is centered. In other words, the inclined projecting pieces 36 are located at 0 and 180 degrees on the circumference of the thin portion 40.

As illustrated in FIGS. 5 and 6, the grommet member 10 and the pin member 24 are combined with each other. The shaft portion 25 of the pin member 24 is inserted into the insertion hole 12 of the grommet member 10 and is engaged with the leg portions 18 and 19 of the grommet member 10.

Here, the process of engaging the pin member 24 and the grommet member 10 with each other is described with reference to drawings. As illustrated in FIGS. 7, 8, and 9, the leg portions 18 and 19 of the grommet member 10 are inserted into a mounting hole 2, which is formed in the mounting member 1. In this case, the ribs 21 of each first leg portion 18 come into contact with the edge inside the mounting hole 2. In this state, the shaft portion 25 of the pin member 24 is inserted into the insertion hole 12 of the grommet member 10. The front end portion 29 of the shaft portion 25 that has passed through the insertion hole 12 comes into contact with the bulging portions 22 of the second leg portions 19 and moves forward while spreading the second leg portions 19. Thus, the second leg portions 19 are bent and open toward the outside. The front end portion 29 that has passed through the bulging portions 22 comes into contact with the locking pieces 23 of the first leg portions 18 and moves forward while spreading the first leg portions 18. Thus, the first leg portions 18 are bent and open toward the outside. When the front end portion 29 passes through the locking pieces 23, the temporary fixing groove portion 31 of the shaft portion 25 faces the bulging portions 22. Thus, the second leg portions 19 return to the original state, and the bulging portions 22 are disposed in the temporary fixing groove portion 31. Simultaneously, the first leg portions 18 also return to the original state. The locking pieces 23 are disposed in the temporary fixing groove portion 31. In this state, the pin member 24 is temporarily fixed to the grommet member 10.

When the pin member 24 is further pushed, the inclined surface 32 of the pin member 24 comes into contact with the bulging portions 22 and moves forward while spreading the second leg portions 19. Thus, the second leg portions 19 are bent and open toward the outside. The inclined surface 32 rubs against the bulging portions 22, comes into contact with the locking pieces 23, and moves forward while spreading the leg portions 18 and 19. Thus, the leg portions 18 and 19 are bent and open toward the outside. When the inclined surface 32 passes through the locking pieces 23, the locking groove portion 34 faces the locking pieces 23. Thus, the leg portions 18 and 19 return to the original states, and the locking pieces 23 are disposed in the locking groove portion 34. In this state, the pin member 24 is engaged with the grommet member 10.

In this engaged state, the projecting portion 13 of the grommet member 10 is inserted into the recessed groove portion 41 of the pin member 24. At the back closer to the projecting portion 13 than the seat portion 11, the support portion 26 faces the projecting portion 13 in a side direction that is a direction crossing the shaft portion 25. The flange portion 35 covers the projecting portion 13. That is, the support portion 26, the cover portion 39, and the top portion 37 cover the projecting portion 13, and the tip end of the thin portion 40 is bent by being pushed against the step portion 15 of the grommet member 10. As a result, the thin portion 40 comes into pressure contact with the seat portion 11, thus making the back side of the seat portion 11 watertight. The inclined projecting pieces 36 of the flange portion 35 are each disposed between the corresponding step pieces 16 of the grommet member 10.

When the engaged state is released, a tool is inserted into the insertion groove 38 of the pin member 24, and the pin member 24 is turned with the tool. Thus, the inclined projecting pieces 36 of the pin member 24 mount the respective step pieces 16 of the grommet member 10, and the pin member 24 rises from the grommet member 10. Simultaneously, the shaft portion 25 is disconnected from the leg portions 18 and 19.

Next, operations and effects of the present embodiment will be described.

In the present embodiment, around the periphery of the insertion hole 12 of the grommet member 10, the projecting portion 13, which has a ring shape or a cylindrical shape where the insertion hole 12 is centered, projects from the opposite side of the seat portion 11 from the leg portions 18 and 19. On the other hand, the pin member 24 includes the recessed groove portion 41, which has a ring shape whose part is formed by the support portion 26, which has a ring shape or a cylindrical shape and is connected, on an extension of the shaft portion 25, between the middle portion 27 of the shaft portion 25 and the flange portion 35. With this configuration, in a state in which the pin member 24 is engaged with the grommet member 10, the projecting portion 13 is inserted into the recessed groove portion 41 behind the seat portion 11. In the recessed groove portion 41, the side of the support portion 26 faces the projecting portion 13 behind the seat portion 11. In other words, since the projecting portion 13 is located around the periphery of the insertion hole 12, the insertion hole 12 is a cylindrical hole, due to the projecting portion 13, simulatively extending toward the back from the seat portion 11. The shaft portion 25 and the support portion 26 of the pin member 24 are inserted into the insertion hole 12 having a cylindrical shape.

When a certain force F is applied to the grommet member 10 from the side in a direction in which the grommet member 10 shifts from the mounting member 1 (up-down direction in FIG. 8), the projecting portion 13 extends at a position to which the pin member 24 is pushed by the inside of the insertion hole 12 to incline the pin member 24, and the support portion 26 comes into contact with the projecting portion 13, thus inhibiting the pin member 24 from being inclined. That is, it can be said that the present embodiment has a high shear strength.

In the state in which the pin member 24 is engaged with the grommet member 10, the projecting portion 13 of the grommet member 10 is inserted into the recessed groove portion 41. Accordingly, the pin member 24 is inhibited from being inclined. That is, it can be said that the present embodiment has a high shear strength.

In particular, the circumferential surface of the support portion 26 having a ring shape or a cylindrical shape and the circumferential surface of the projecting portion 13 having a ring shape or a cylindrical shape entirely come into contact with each other. Accordingly, the support portion 26 and the projecting portion 13 are strong, thus achieving a high shear strength.

In the present embodiment, the flange portion 35 of the pin member 24 includes the top portion 37, which is circular and flat and is connected to the support portion 26, the cover portion 39, which has a ring shape or a cylindrical shape and projects toward the front from the periphery of the top portion 37, and the thin portion 40, which has a ring shape and projects toward the outside from the front end of the cover portion 39. In the state in which the pin member 24 is engaged with the grommet member 10, the flange portion 35 covers the projecting portion 13, and the tip end of the thin portion 40 is bent by being pushed against the step portion 15 of the grommet member 10. As a result, the thin portion 40 comes into pressure contact with the seat portion 11, thus enabling the back side of the seat portion 11 to be watertight. In addition, since the pin member 24 is inhibited from being inclined, the flange portion 35 is not deformed, thus enabling the watertightness to be maintained.

In the present embodiment, the base portion 20 of the first leg portion 18 has the ribs 21 on the outer side thereof. That is, the ribs 21 increase the rigidity of the first leg portion 18. Thus, the grommet member 10 is less likely to shift. In addition, when the leg portions 18 and 19 of the grommet member 10 are inserted into the mounting hole 2 of the mounting member 1, the ribs 21 come into contact with the edge inside the mounting hole 2. With this configuration, even when the certain force F is applied to the grommet member 10 from the side in the direction in which the grommet member 10 shifts from the mounting member 1, the ribs 21 come into contact with the edge of the mounting hole 2. Thus, the grommet member 10 is less likely to shift. That is, it can be said that the present embodiment has a high shear strength.

In another embodiment of the present invention, only the base portion of the second leg portion has the ribs.

In still another embodiment thereof, the base portion of the first leg portion and the base portion of the second leg portion have the ribs.

In still another embodiment thereof, the shape, the number, and the positions of the ribs of the base portion may be freely determined.

In still another embodiment thereof, the projecting portion does not have a continuous ring shape but has a shape in which a plurality of projections is arranged so as to form a ring shape.

In still another embodiment thereof, the projecting portion of the grommet member and the support portion of the pin member are formed at respective positions away from the insertion hole of the grommet member and the shaft portion of the pin member in a side direction.

In still another embodiment thereof, the pin member does not include the flange portion.

Embodiments of the present invention have been specifically described above. However, the present invention is not limited to the embodiments described above. In the present invention, various design changes can be made without departing from the matters described in the claims. For example, the present invention is also usable for conveyances such as automobiles, aircraft, and ships.

### Reference Signs List

1 mounting member
2 mounting hole
3 clip structure
10 grommet member
11 seat portion
12 insertion hole
13 projecting portion
14 wall portion
15 step portion
16 step piece
17 leg portion
18 first leg portion
19 second leg portion
20 base portion
21 rib
22 bulging portion
23 locking piece
24 pin member
25 shaft portion
26 support portion
27 middle portion
28 front-end locking portion
29 front end portion
30 temporary fixing portion
31 temporary fixing groove portion
32 inclined surface
33 partition portion
34 locking groove portion
35 flange portion
36 inclined projecting piece
37 top portion
38 insertion groove
39 cover portion
40 thin portion
41 recessed groove portion
F force

1. A clip structure comprising:
a grommet member having an insertion hole around which a leg portion is disposed, the leg portion being formed on a seat portion configured to face a mounting member, the leg portion being configured to be inserted into the mounting member; and
a pin member including a shaft portion that is inserted into the insertion hole and that is engaged with the leg portion, wherein
the grommet member includes a projecting portion projecting toward an opposite side of the seat portion from the leg portion, and
the pin member includes a support portion configured to come into contact with the projecting portion, in a direction crossing the shaft portion, at a position closer to the projecting portion than the seat portion.

2. The clip structure according to claim 1, wherein
the shaft portion and the support portion are connected to each other,
a flange portion is connected to the support portion, and
the support portion and the flange portion form a shape of a recessed groove into which the projecting portion is inserted.

3. The clip structure according to claim 2, wherein the flange portion includes a thin portion configured to come into pressure contact with the seat portion.

4. The clip structure according to claim 1, wherein the leg portion has a rib configured to come into contact with an edge of a hole of the mounting member.

5. The clip structure according to claim 1, wherein
the projecting portion has a ring shape around an edge of the insertion hole, and
the support portion has a ring shape on an extension of the shaft portion.

6. A pin member configured to be engaged with a grommet member having an insertion hole around which a leg portion is disposed, the leg portion being formed on a seat portion configured to face a mounting member, the leg portion being configured to be inserted into the mounting member, the pin member comprising:
a shaft portion that is configured to be inserted into the insertion hole and that is configured to be engaged with the leg portion;
a recessed groove portion that has a ring shape and that is recessed, on an extension of the shaft portion on an opposite side of the seat portion from the leg portion, toward a side opposite to the shaft portion, a part of the grommet member being configured to be inserted into the recessed groove portion;
a support portion that is connected on the extension of the shaft portion and that is a part of the recessed groove portion; and
a thin portion that is connected to the recessed groove portion and that is configured to come into pressure contact with the seat portion.

7. The clip structure according to claim 2, wherein the leg portion has a rib configured to come into contact with an edge of a hole of the mounting member.

8. The clip structure according to claim 3, wherein the leg portion has a rib configured to come into contact with an edge of a hole of the mounting member.

9. The clip structure according to claim 2, wherein
the projecting portion has a ring shape around an edge of the insertion hole, and
the support portion has a ring shape on an extension of the shaft portion.

10. The clip structure according to claim 3, wherein
the projecting portion has a ring shape around an edge of the insertion hole, and
the support portion has a ring shape on an extension of the shaft portion.

11. The clip structure according to claim 4, wherein
the projecting portion has a ring shape around an edge of the insertion hole, and
the support portion has a ring shape on an extension of the shaft portion.

12. The clip structure according to claim 7, wherein
the projecting portion has a ring shape around an edge of the insertion hole, and
the support portion has a ring shape on an extension of the shaft portion.

13. The clip structure according to claim 8, wherein
the projecting portion has a ring shape around an edge of the insertion hole, and
the support portion has a ring shape on an extension of the shaft portion.
